(19) United States
(12) Patent Application Publication
(10) Pub. No.: US 2014/0001225 A1
(43) Pub. Date: Jan. 2, 2014

(54) STAPLER

(71) Applicant: Olle Strååt, Hestra (SE)

(72) Inventor: Olle Strååt, Hestra (SE)

(73) Assignee: ISABERG RAPID AB

(21) Appl. No.: 14/005,264

(22) PCT Filed: Mar. 3, 2012
(86) PCT No.: PCT/SE2012/000025

§ 371 Date: Sep. 14, 2013

(30) Foreign Application Priority Data
Mar. 15, 2011 (SE) 1100189-8

(51) Int. Cl. B27F 7/17

(52) U.S. Cl. CPC B27F 7/17
USPC 227/79

(57) ABSTRACT

Stapler (1) for using a staple (6) to staple together a workpiece (24), e.g. a sheaf of papers, by the staple being driven through the workpiece, by a driver (11) fitted in the stapler, from a staple magazine (5) to a position in which the staple legs penetrate the workpiece, which stapler comprises also a clipping arrangement (14), which moves reciprocatingly relative to the staple magazine in a defined direction (H) between a working position and a position of rest so that the clipping arrangement in the working position clips off surplus lengths of the staple legs when they have penetrated the workpiece, and a container (12) for gathering the staple leg clippings by their being conveyed via a channel (15) which runs in a defined longitudinal direction (A-A) between the clipping arrangement and the container, which channel (15) is attached pivotably to the stapler by means of a connecting device (16).

### TECHNICAL FIELD

The present invention relates to a stapler for using a staple which comprises a crown portion and, angled thereto, staple legs, to staple together a workpiece, e.g. a sheaf of papers, by the staple being driven through the workpiece, by a driver fitted in the stapler, from a staple magazine to a position in which the staple legs penetrate the workpiece, which stapler comprises also an anvil portion equipped with a clipping arrangement, which anvil portion and clipping arrangement move reciprocatingly relative to the staple magazine in a defined direction between a working position and a position of rest so that the clipping arrangement in the working position clips off surplus lengths of the staple legs when they have penetrated the workpiece, and a container for gathering the staple leg clippings by their being conveyed via a channel which runs in a defined longitudinal direction between the clipping arrangement and the container.

### STATE OF THE ART

Staplers of the kind indicated in the introduction are previously known, e.g. from U.S. Pat. No. 4,844,319, EP 1834745, EP 1779977 and EP 1683616, to mention but a few. The disadvantage of these earlier staplers is that the channel is fitted firmly to the stapler. This means that the stapler when used has to be so placed relative to the horizontal plane that the staple leg clippings are conducted through the channel by force of gravity. This means that the potential choices for placing the stapler relative to the horizontal plane are limited. EP 1834745 refers to a stapler in which the channel is connected firmly to, and accompanies the movement of, the anvil portion. This somewhat increases the scope of potential choices for placing the stapler relative to the horizontal plane. EP 1779977 refers to a stapler which has double and separate channels which likewise increase the scope of potential choices for placing the stapler relative to the horizontal plane. EP 1683616 discloses a stapler which has a channel which consists of a first and a second part of which the first is firmly connected to the clipping arrangement and the second pivotably connected to the first part.

However, all previous staplers provide a solution with limited scope for placing the stapler at varying angles of inclination relative to the horizontal plane while at the same time ensuring reliable conveying of the leg clippings to the container.

### PROBLEM

There is therefore a need for a stapler so configured as to be usable while maintaining the function of conveying leg clippings through the channel within a larger range of variation of angles of inclination between the stapler and the horizontal plane.

### THE INVENTION

The present invention proposes a stapler which provides a solution to the problems of previous staplers. The invention proposes a stapler of the kind indicated in the introduction which is characterised in that the channel is adapted to being pivotable relative to the stapler.

The invention is also characterised in that the channel has a sleeve connected pivotably about a spindle which is fitted to the stapler and which accompanies the reciprocating movement of the clipping arrangement.

The invention is also characterised in that this sleeve takes the form of an open sleeve.

The invention is also characterised in that said spindle rotates.

The invention is further characterised in that said spindle has a non-circular cross-section.

The invention is further characterised in that the channel comprises a spindle connected pivotably to a sleeve which is fitted to the stapler and which accompanies the reciprocating movement of the clipping arrangement.

Also characterising for the invention is the fact that the angle between the direction of movement of the clipping arrangement and the longitudinal direction of the channel varies depending on where in the reciprocating movement the clipping arrangement is.

### BRIEF DESCRIPTION OF THE DRAWINGS

The invention is described below with reference to the attached drawings, in which:

FIG. 1 is a schematic view of a stapler equipped with the present invention, showing the stapler in its position of rest;

FIG. 2 is a view corresponding to FIG. 1 in which the stapler is in its working position;

FIGS. 3-6 are detailed views of parts which are essential to the invention and

FIG. 7 is a detailed view of a staple.

### PREFERRED EMBODIMENT

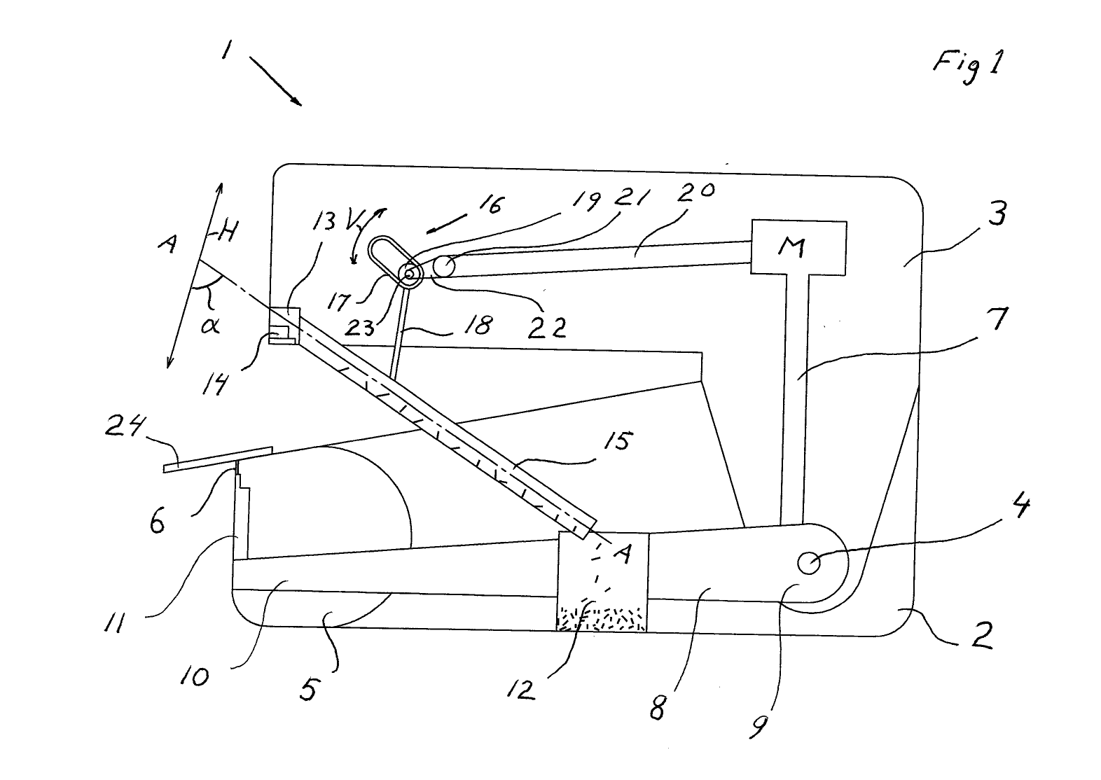

FIG. 1 depicts very schematically a stapler 1 which comprises the present invention. It only shows clearly those parts which are necessary for proper understanding of the invention. Parts and solutions which are obvious to specialists are only schematically depicted. In the figure the stapler is in a position of rest and the figure discloses that the stapler comprises a lower element 2 and an upper element 3 which are pivotably connected to one another by a spindle 4. In the lower element 2 there is a staple magazine 5 accommodating staples which are not visible in the drawing other than a schematically depicted staple 6 which is in its driving position. In the upper element 3 there is a motor M actively connected by a link arrangement 7 to a lever arm 8 which has a first end 9 connected pivotably to the spindle 4. The lever arm 8 has its opposite end 10 to the first end 9 connected to a driver 11 which is situated in or close to the magazine 5. In the lower element there is also a container 12 whose function is indicated in the description below. The upper element 3 comprises an anvil portion 13 provided with a clipping arrangement 14. A channel 15 runs between the anvil portion 3 and the container 12 and is connected pivotably by a connecting device 16 to the upper element 3 in the direction indicated by the double arrow V. The connecting device comprises an elongate sleeve 17 which by an intermediate link 18 is firmly connected to the channel 15. The connecting device comprises also a spindle 19 which is connected to the upper element 3 and about which the sleeve 17 is connected. A first transmission means 20 extends from the motor M to rotate a wheel 21 which is connected rotatably to the upper element. A second transmission means 22 runs from the wheel 21 and is connected to a hub 23 which is connected to the spindle 19. The spindle 19 is fastened rotatably in the upper element 3. The figure also depicts a workpiece 24 preferably consisting of two or more sheets of paper to be stapled together by the stapler by means of a staple 6. The fact that the upper and lower elements are joined together pivotably by the spindle 4 makes it possible for the upper element to be moved relative to the lower element in a reciprocating stapling movement in a direction indicated by the double arrow H. The broken line A-A represents the longitudinal line of the channel 15 which forms an angle a with the direction H of the stapling movement.

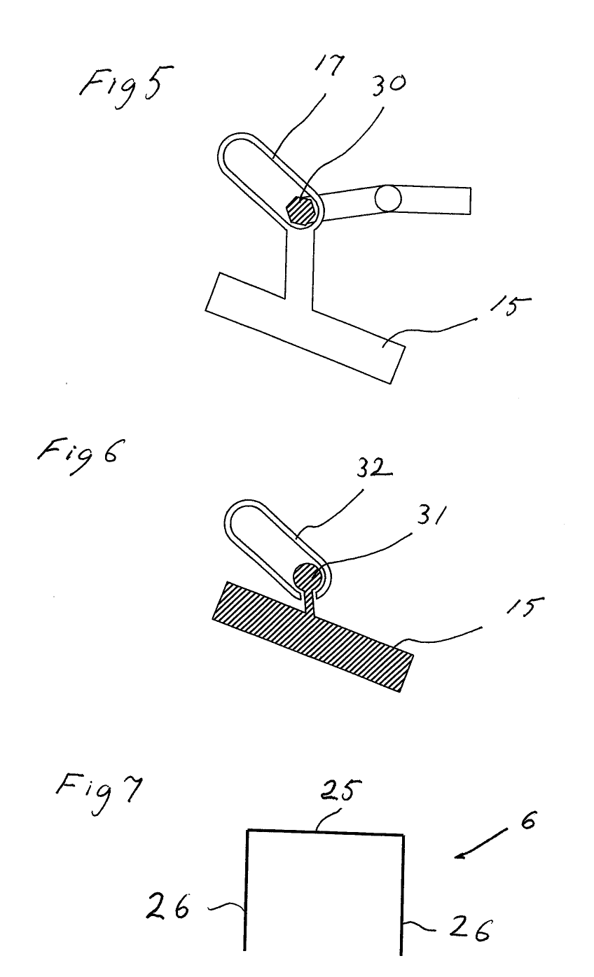

FIG. 7 depicts a staple 6 comprising a crown portion 25 and, angled thereto, legs 26.

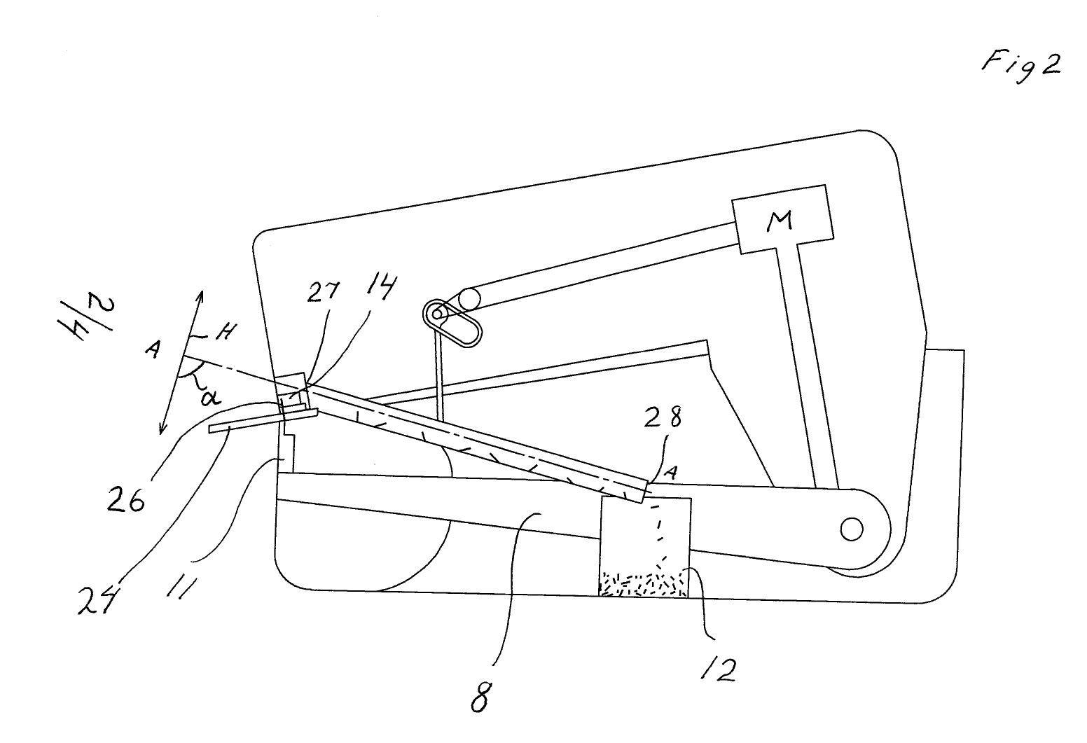

FIG. 2 shows a situation where the motor M has driven the upper element 3 towards the lower element 2 in the stapling movement from the position of rest in which the stapler is depicted in FIG. 1 to a working position depicted in FIG. 2. The figure also shows the lever arm 8 with the driver 11 having driven the staple 6 through the workpiece 24 so that the staple legs 26 extend into the anvil portion and to the clipping arrangement 14. In this situation the connecting device 16 will have pivoted the channel 15 in the direction V with the result that the angle a is more obtuse than when the stapler is in the position of rest. A first end 27 of the channel 15 is close to the clipping arrangement 14. The connection of the channel to the clipping arrangement may be by a bellows which connects the channel and the clipping arrangement, possibly by the clipping arrangement 14 being provided with an aperture into which the channel is inserted or possibly by any other form of connection known to specialists which provides assurance that the staple leg clippings cut off by the clipping arrangement will reliably be conducted from the clipping arrangement to the channel. The other end 28 of the channel leads into the container 12. In this working position the clipping arrangement cuts surplus lengths off from the staple legs in ways known to specialists and the clippings are conducted into the channel 15 and conveyed to the container 12. This clipping and conducting to the channel is not depicted other than as schematically represented in the drawings, but is generally known to specialists and may be effected in various different ways, so no detailed description is given herein.

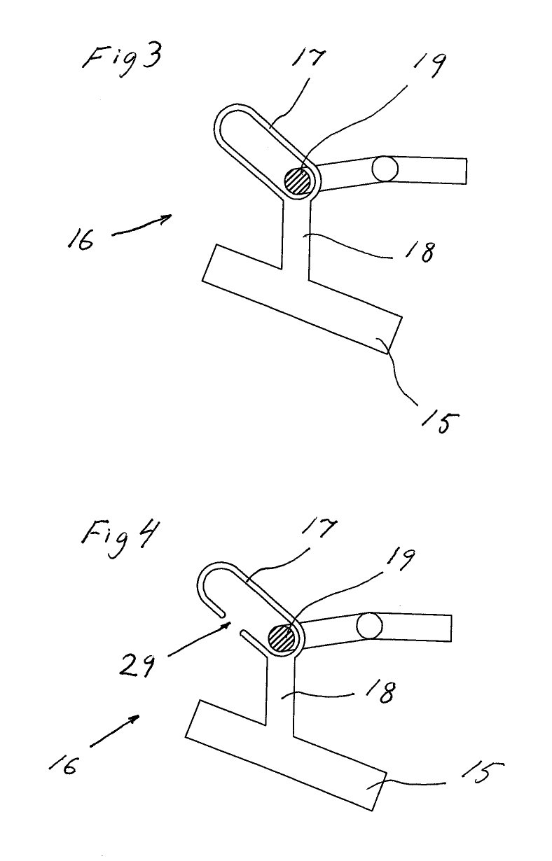

FIG. 3 depicts in detail the connecting device 16 which appears in FIGS. 1 and 2. FIG. 4 depicts an alternative connecting device in which the elongate sleeve has an aperture 29 to facilitate the fitting of the sleeve to the spindle. FIG. 5 depicts a spindle 30 with a non-circular cross-section such that when the spindle rotates, the channel will, when moved from the working position to the position of rest, be vibrated, thereby further improving the conveying of the staple leg clippings through the channel. In FIG. 6 the channel is provided with a spindle 31 and the upper element has a sleeve 32 fitted to it.

The fact that the channel is connected pivotably to the upper element means that the angle a between the channel's longitudinal line A-A and the direction H of the stapling movement will vary depending on where in the stapling movement the anvil portion is, and the angle will be more acute in the position of rest than in the working position. This results in reliable conveying of the staple leg clippings through the channel to the container 12 within a greater range of variation of the stapler's placing relative to the horizontal plane than if the channel was firmly connected to the upper element 3.

The invention is not limited by the above description but only by the claims set out below.

1. A stapler (1) for using a staple (6) which comprises a crown portion (25) and, angled thereto, staple legs (26), to staple together a workpiece (24), e.g. a sheaf of papers, by the staple being driven through the workpiece, by a driver (11) fitted in the stapler, from a staple magazine (5) to a position in which the staple legs penetrate the workpiece, which stapler comprises also an anvil portion (13) equipped with a clipping arrangement (14), which anvil portion and clipping arrangement move reciprocatingly relative to the staple magazine in a defined direction (H) between a working position and a position of rest so that the clipping arrangement in the working position clips off surplus lengths of the staple legs when they have penetrated the workpiece, and a container (12) for gathering the staple leg clippings by their being conveyed via a channel (15) which runs in a defined longitudinal direction (A-A) between the clipping arrangement and the container characterised in that the channel (15) is attached pivotably to the stapler by means of a connecting device (16).

2. A stapler (1) according to claim 1, characterised in that the connecting device (16) comprises a sleeve (17) which is connected to the channel (15) and pivotably connected to a spindle (19) fitted to the stapler and which accompanies the reciprocating movement of the clipping arrangement.

3. A stapler (1) according to claim 2, characterised in that the sleeve has an aperture (29).

4. A stapler (1) according to claim 2, characterised in that the spindle (19) rotates.

5. A stapler (1) according to claim 2, characterised in that the spindle (30) has a non-circular cross-section.

6. A stapler (1) according to claim 1, characterised in that the connecting device (16) comprises a spindle (31) connected to the channel (15) and pivotably connected to a sleeve (32) which is fitted to the stapler and which accompanies the reciprocating movement of the clipping arrangement.

7. A stapler (1) according to claim 1, characterised in that the angle (α) between the direction of movement (H) of the clipping arrangement and the longitudinal direction (A-A) of the channel varies depending on where in the reciprocating movement the clipping arrangement is.

8. A stapler (1) according to claim 3, characterised in that the spindle (19) rotates.

9. A stapler (1) according to claim 8, characterised in that the spindle (30) has a non-circular cross-section.

10. A stapler (1) according to claim 3, characterised in that the spindle (30) has a non-circular cross-section.

11. A stapler (1) according to claim 4, characterised in that the spindle (30) has a non-circular cross-section.

12. A stapler (1) according to claim 2, characterised in that the angle (α) between the direction of movement (H) of the clipping arrangement and the longitudinal direction (A-A) of the channel varies depending on where in the reciprocating movement the clipping arrangement is.

13. A stapler (1) according to claim 3, characterised in that the angle (α) between the direction of movement (H) of the clipping arrangement and the longitudinal direction (A-A) of the channel varies depending on where in the reciprocating movement the clipping arrangement is.

14. A stapler (1) according to claim 4, characterised in that the angle (α) between the direction of movement (H) of the clipping arrangement and the longitudinal direction (A-A) of the channel varies depending on where in the reciprocating movement the clipping arrangement is.

15. A stapler (1) according to claim 5, characterised in that the angle (α) between the direction of movement (H) of the clipping arrangement and the longitudinal direction (A-A) of the channel varies depending on where in the reciprocating movement the clipping arrangement is.

16. A stapler (1) according to claim 6, characterised in that the angle (α) between the direction of movement (H) of the clipping arrangement and the longitudinal direction (A-A) of the channel varies depending on where in the reciprocating movement the clipping arrangement is.
